(19) United States
(12) Patent Application Publication
(10) Pub. No.: US 2024/0383711 A1
(43) Pub. Date: Nov. 21, 2024

(54) METHOD FOR WINDING A FOIL ONTO A WINDING CORE, AND COIL

(71) Applicant: Volkswagen Aktiengesellschaft, Wolfsburg (DE)

(72) Inventors: Tobias JANSEN, Braunschweig (DE); Kristian LIPPKY, Braunschweig (DE)

(73) Assignee: Volkswagen Aktiengesellschaft, Wolfsburg (DE)

(21) Appl. No.: 18/787,362

(22) Filed: Jul. 29, 2024

Related U.S. Application Data
(63) Continuation of application No. PCT/EP2023/051852, filed on Jan. 26, 2023.

(30) Foreign Application Priority Data
Jan. 27, 2022 (DE) 10 2022 101 890.3

(51) Int. Cl. B65H 19/28; B65H 18/10; H01M 4/04

(52) U.S. Cl. CPC B65H 19/283; B65H 18/103; B65H 2301/41426; B65H 2701/1842; B65H 2701/19; B65H 2701/52; H01M 4/04

(57) ABSTRACT

A method for winding a foil onto a winding core in order to form a coil and for unwinding the foil from the winding core. The foil comprises a support material of an electrode foil and an electrode foil, which has at least one active material, or a separator foil which are used as components of a battery cell. The winding core has a perforated circumferential surface with at least one opening. A coil is also provided that has at least a winding core and a foil which is wound on the winding core.

This nonprovisional application is a continuation of International Application No. PCT/EP2023/051852, which was filed on Jan. 26, 2023, and which claims priority to German Patent Application No. 10 2022 101 890.3, which was filed in Germany on Jan. 27, 2022, and which are both herein incorporated by reference.

### BACKGROUND OF THE INVENTION

### Field of the Invention

The invention relates to a method for winding a foil onto a winding core and a coil, comprising a winding core and a foil which is wound on the winding core. The method and the coil or winding core are used in particular for unwinding and winding electrode foils, in particular coated and/or uncoated electrode foils.

### Description of the Background Art

Batteries, especially lithium-ion batteries, are increasingly being used to power motor vehicles. Batteries are usually composed of battery cells, with each battery cell having a stack of anode, cathode and separator foils, which may be in the form of layers or layers of material. At least some of the anode and cathode foils are designed as electrical current arresters to discharge the current provided by the battery cell to a consumer located outside the battery cell. The individual elements of a stack are also referred to as electrodes or foils in the following.

The individual foils are provided in particular as continuous material, if necessary coated, e.g., with an active material and wound again. The foils produced in this way are then fed into a process for the production of battery cells as a coiled coil. There, the coils, which may include coated electrode foils, are unwound and, for example, trimmed or separated into individual layers or divided so that the individual layers can be stacked on top of each other. Uncoated areas of coated foils can be used as arresters.

In particular, the coils comprise a so-called winding core, on which the foils are wound and from which the foils are later unwound.

In view of the ongoing automation of production chains in factories for the production of (lithium-ion) battery cells, it is imperative to improve the interlinking between the individual machines. Such a production chain includes in particular the process of coating (i.e., in particular the coating of a support material with an active material) and stacking (the stacking of the individual layers of foils). In particular, these processes include a variety of splicing (i.e., connection methods for connecting electrode foils to form a continuous material) and cutting operations (for trimming or separating individual layers of electrode foils from a continuous material). In particular, these processes or methods enable a continuous production process.

A splice bonding process is used in particular when unwinding a continuous material from a coil. Once a first foil has been completely unrolled from the coil, a new second foil of a new coil already available in the machine is automatically added to the end of the first foil. This bond between the first foil and the second foil is called the splice or joint. Afterwards or before, the end of the first foil must be separated from the coil or the winding core in order to decouple the empty winding core from the process and remove it from the machine. The empty winding core can then be replaced with a new coil.

In particular, the continuous material of the first foil is rewound onto a (different) winding core after passing through the process, e.g. after coating the first foil. After the splice has passed through the process (that is, e.g., after the foil has been coated), the first foil must be again separated from the second foil, especially behind the splice (at a separation point) so that the coil comprising the first foil can be removed from the machine. Following this separation point, the end of the second foil is reattached to a new or empty winding core, so that error-free winding can be guaranteed.

The separation of the continuous material, i.e., the creation of the separation point, is carried out industrially in particular by a knife cut or a rotary knife cut and is characterized by complex automation technology.

The bonding of the foil material to the winding core is carried out industrially, in particular as a bonding process, and is also characterized by complex automation. The challenges here lie in particular in the application of the adhesive tape to the foil or to the winding core.

The main disadvantages of these processes, i.e., in the creation of the separation point and the bonding of the foil to the winding core, are that these two complex processes are generally used for a fully automated change of the coils and thus in principle represent sources of error that can greatly reduce the availability of the machines. Furthermore, the separation or cutting process leads to an additional formation of ablation products, which can lead to contamination of the electrode surfaces and thus to an impairment of the composite comprising the electrode foils and separator material.

The inserted adhesive strip used to fix or bond the foil to the winding core can lead to an inhomogeneous load on the foil. Furthermore, these glued areas must be cleaned if the winding cores are to be reused.

From CN 108461825 A, a device for applying an adhesive to electrode foils is known.

A device for applying adhesive strips to electrode foils is known from CN 109411831 A. A vacuum sleeve for fixing the adhesive strips is described therein.

From CN 212434693 U, a device for providing an adhesive foil is known, which is used for the production of electrode foils.

### SUMMARY OF THE INVENTION

It is therefore an object of the present invention to solve, at least in part, the problems cited with regard to the prior art. In particular, the processes of separating the continuous material and joining the continuous material with a winding core are to be improved, i.e., replaced in particular by a leaner, simpler and more robust technology, so that a high degree of automation of the production chain can be ensured.

An example of a method of winding a foil onto a winding core to form a coil and/or unwinding the foil from the winding core is provided. The foil includes, in particular, a support material of an electrode foil, an electrode foil which has at least one active material, or a separator foil, each of which is used as a component of a battery cell. The winding process comprises at least the following steps: (a) providing the winding core and arranging the winding core on a shaft; (b) providing the foil as a continuous material, with the foil having a first end; (c) arranging the first end on the winding core; and (d) winding the foil on the winding core and forming the coil.

The winding core has a perforated circumferential surface with at least one opening. The foil is arranged on the perforated circumferential surface in steps c) and d). The winding core is connected to a vacuum source, which generates a vacuum at least at one opening, so that the vacuum fixes the foil to the circumferential surface at least during step c), in particular during step d).

The above (non-exhaustive) classification of the method steps into a) to d) is primarily intended to serve as a distinction and not to enforce a sequence and/or dependency. The frequency of the method steps can also vary. It is also possible that method steps overlap each other in time, at least in part. Particularly preferred, the steps a) and b) take place prior to steps c) and d). In particular, steps a) and b) take place in parallel to each other. In particular, step c) takes place prior to step d). In particular, steps a) to d) are carried out in the order indicated.

In particular, a battery cell comprises a housing enclosing a volume and arranged in the volume, at least one electrode foil of a first type of electrode (e.g., an anode), an electrode foil of a second type of electrode (e.g., a cathode) and a separator material arranged in between, as well as an electrolyte, e.g., a liquid or a solid electrolyte.

In particular, the battery cell is a pouch cell (with a deformable housing consisting of a pouch foil) or a prismatic cell (with a rigid housing).

A pouch foil is a well-known deformable housing part that is used as a housing for so-called pouch cells. It is a composite material, e.g., containing a plastic and aluminum.

The battery cell is in particular a lithium-ion battery cell or another type of battery cell.

The individual foils of the majority of electrode foils are arranged on top of each other and form a stack, in particular. The electrode foils are each assigned to different types of electrodes, i.e., they are designed as an anode or a cathode. Anodes and cathodes are arranged alternately, each separated from each other by the separator material.

A battery cell is an electricity storage device that is used, for example, in a motor vehicle to store electrical energy. In particular, a motor vehicle, for example, has an electric machine to drive the motor vehicle (a traction drive), wherein the electric motor can be driven by the electrical energy stored in the battery cell.

The method is aimed in particular at the winding and unwinding of a foil, wherein the foil wound on the winding core, together with the winding core, is referred to as a coil.

The winding core has a perforated circumferential surface with at least one opening. The circumferential surface is in particular cylindrical or hollow cylindrical. The winding core is particularly suitable for arrangement on a shaft, i.e., it has connection dimensions or connection geometries suitable for connection to the shaft. The shaft serves in particular for the arrangement and/or (if necessary additionally) the drive, i.e., the rotation of the winding core, so that, for example, the rotation of the shaft causes the winding core to rotate. As a result of the arrangement on the shaft, the foil can be wound on the winding core or unwound from the winding core.

In particular, the shaft can be part of a device that has at least the vacuum source. For example, the vacuum source can be connected to the shaft and/or to the winding core by means of a suitable connection, so that at the at least one opening there is a negative pressure generated or provided by the vacuum source (a negative pressure relative to the vicinity of the device). The connection can be made, for example, via a rotary coupling so that the fixed vacuum source can be connected to the rotating shaft and/or the rotating winding core.

For example, the shaft can also be designed as a core with a perforated surface, wherein this perforation serves in particular only to transfer the negative pressure from the vacuum source to the circumferential surface. Alternatively, the shaft can also be designed with a closed circumferential surface. The winding core can, for example, have a frontal connection for the vacuum source, wherein the circumferential surface is arranged at a distance from the shaft, so that the negative pressure of the vacuum source can be provided at the at least one opening via the (cylindrical) gap between the circumferential surface and the shaft.

The vacuum can be used in particular to fix the foil to the circumferential surface. In particular, fixing can mean that a pressure force or suction force is provided by which the foil is pressed or sucked onto the circumferential surface.

The foil includes, in particular, a support material of an electrode foil, an electrode foil which has at least one active material, or a separator foil, which are used as components of a battery cell. The support material includes in particular a metallic material, e.g., a material or alloy comprising copper or aluminum.

In particular, the foil does not contain any adhesive components that could cause the foil to adhere to the circumferential surface of the winding core.

In step a), in particular, the winding core and arrangement of the winding core on a shaft are provided. The winding core can be pushed onto the shaft, for example.

In step b), in particular, the foil is provided as a continuous material, wherein the foil has a first end. The first end is arranged on the circumferential surface, fixed there via the vacuum and then the foil is wound. In particular, the foil extends over at least one rotation of the winding core, in particular over several layers of the foil, up to a second end of the foil. The second end can be formed, for example, by a separation point.

In step c), in particular, the first end is arranged on the winding core. The arrangement can be done, for example, by means of a feeder through which the foil is directed to the winding core. The foil rests on the circumferential surface via the first end and is applied over the at least one opening on the circumferential surface. While arranging, the winding core can stand still or rotate. The foil can be applied to the circumferential surface or continuously fed to the winding core. The arranging shall include, in particular, the winding of the foil, at least to the extent that the foil is in contact with the circumferential surface along the circumferential direction with an angle range of zero to 360, in particular at least 15 angular degrees and a maximum of 345 angular degrees.

In particular, during step c), at least partially/possibly fully during step c), the negative pressure is applied to the opening, so that the foil is brought to bear on the circumferential surface and in particular fixed there.

In step d), in particular, the foil is wound on the winding core and the coil is formed. Winding includes in particular the winding of the foil to such an extent that the foil rests on the circumferential surface along the circumferential direction with an angle range of more than zero, in particular of more than 15 angular degrees, preferably of more than 345 or even of 360 angular degrees.

In particular, if at least one layer of the foil is arranged on the winding core and thus fixes itself to the circumferential surface via the layers overlapping each other along the circumferential direction, the negative pressure can also be switched off again during step d).

In particular, no adhesive material is placed on the circumferential surface of the winding core during steps c) and d), so that the foil adheres to the circumferential surface solely due to the negative pressure.

The method avoids the use of adhesive materials, e.g., adhesive tape, which was previously used to fix the foil to a winding core. Accordingly, no separation of the foil is necessary, so that this method step and the associated risk of contaminating the devices used or the workpiece, e.g., by ablation, can be avoided. In particular, this allows for a fully automated winding of the foil to be realized, wherein method steps that would otherwise be considered necessary, such as separating or cutting as well as gluing the foil to the winding core, can be omitted.

This eliminates the otherwise necessary trimming of the foil, i.e., the separation of the foil from the first end arranged on the circumferential surface, so that material loss can be avoided.

Furthermore, contamination of the winding core by an adhesive material can be avoided. Otherwise necessary steps for cleaning the winding core are now no longer necessary.

In particular, the provision of a vacuum can generate a reproducible suction force that may be adapted to the material used in the foil. With the adhesive materials used so far, the adhesion to the foil was difficult to reproduce.

In addition, changing the winding cores and overall winding and unwinding the foil is simplified, as: no trimming of the foil has to be done; no gluing at the beginning of the winding process takes place; no adhesive residues are present on the winding core or need to be removed from it; the first windings (i.e., the inner layers of the foil of the formed coil) are not affected by thickening in the area of the adhesive tape arranged on the winding core; cleaning processes of the winding core are eliminated; material savings, especially for expensive active material, can be realized; by eliminating the cutting and gluing processes, material can be saved to a large extent, as waste is reduced, and/or cutting systems do not have to be used to separate the foil, wherein wear of the cutting systems can also be avoided and supplies are saved.

In particular, the winding core has an axis of rotation extending along an axial direction.

In particular, the circumferential surface can comprise a plurality of openings. The openings are distributed at least along one circumferential direction, in particular over the entire circumferential surface along the circumferential direction.

Alternatively or additionally, the openings are distributed along the axial direction.

In particular, the openings are at least partly different from each other. The openings can be designed as slits or circles or ellipses, for example.

In particular, the at least one opening is arranged exclusively in a part of the circumferential surface extending along a circumferential direction over an angle range of less than 270 angular degrees, and in particular of less than 180 angular degrees. This allows for the foil to be arranged on the circumferential surface, e.g., in step c), with the foil covering the at least one opening. This can improve the suction of the foil, as all or at least a large part of the openings are covered by the foil. If, for example, the entire circumferential surface is perforated along the circumferential direction, it is possible that the negative pressure over the openings not covered by the foil may be reduced, so that sufficient suction may not be guaranteed.

In particular, the winding core comprises a plurality of openings on the circumferential surface arranged in at least one row extending along the axial direction. In particular, the openings of a row are aligned with each other along the axial direction. In particular, the openings of a row are offset from each other along the axial direction (not aligned, but along the circumferential direction).

In particular, the size of the at least one opening and the vacuum at the at least one opening is adjusted to the deformation strength of the foil, so that at least plastic deformation of the foil by the foil being sucked via the at least one opening is avoided.

In particular, when the foil is wound on the winding core, the foil is fixed to the circumferential surface adhesive-free, i.e., without adhesive.

In particular, when the foil is unwound, the foil is completely unwound from the winding core in a continuous process, wherein the winding core is free of adhesives immediately after unwinding. In particular, therefore, there is no separation step in which the first end, which is directly located on the circumferential surface, is separated from the rest of the foil. In particular, the entire foil, up to the first end, is unwound from the winding core, without the foil being separated in between the first end and the second end.

In particular, the foil is unwound from a first winding core and the foil is wound on a second winding core, and the foil is processed in between, e.g., trimmed or coated or dried or calendered. In particular, the foil is unwound from the first winding core with the first end, which directly contacts the circumferential surface of the first winding core and wound with the first end on the second winding core. In particular, there is therefore no separation step in which the first end of the foil, which is directly located on the circumferential surface of the first winding core, is separated from the rest of the foil. In particular, the entire foil, up to the first end, is unwound from the first winding core and preferably also wound on the second winding core. Thus, the foil is not separated between the first end and the second end.

A coil, at least comprising a winding core and a foil which is wound on the winding core, is also proposed. The foil comprises a support material of an electrode foil, an electrode foil which has at least one active material, or a separator foil, which are used as components of a battery cell. The winding core has a perforated circumferential surface contacting the coiled foil with at least one opening.

The coil or the winding core and/or the foil is/are used in particular in the method described. The winding core is used to wind a foil on the winding core to form the coil and to unwind the foil from the winding core or coil.

In particular, the winding core has an axis of rotation extending along an axial direction.

In particular, the circumferential surface includes a plurality of openings. The openings are distributed at least along a circumferential direction, in particular over the entire circumferential surface along the circumferential direction.

The openings can be distributed along the axial direction.

In particular, the openings can be at least partly different from each other. The openings can be designed as slits or circles or ellipses, for example.

In particular, the at least one opening is located exclusively in a part of the circumferential surface which extends along a circumferential direction over an angular range of less than 270 angular degrees, and in particular less than 180 angular degrees. This allows for the foil to be arranged on the circumferential surface, e.g., in step c), with the foil covering the at least one opening. This can improve the suction of the foil, as all or at least a large part of the openings are covered by the foil. If, for example, the entire circumferential surface is perforated along the circumferential direction, the negative pressure can be dissipated via the openings not covered by the foil, so that sufficient suction may not be guaranteed.

In particular, the winding core comprises a plurality of openings on the circumferential surface, which are arranged in at least one row extending along the axial direction. In particular, the openings of a row are aligned with each other along the axial direction.

In particular, the size of the at least one opening and the vacuum at the at least one opening are adjusted to the deformation strength of the foil, so that at least plastic deformation of the foil by sucking the foil through at least one opening is avoided.

A device is also proposed, at least comprising a shaft, a winding core that can be arranged on the shaft and a vacuum source. The vacuum source can be connected to the shaft and/or to the winding core, for example, via a suitable connection or coupling. In particular, the device is designed to be suitable for carrying out the method.

The method can be carried out in particular by means of a data processing system, such as a control unit, wherein the system has components that are suitably equipped, configured or programmed to carry out the steps of the method or which carry out the method. The system can be used to, at least feed the foil to the winding core; apply the foil to the winding core; adjust the negative pressure; adjust the rotation of the shaft or the winding core; and/or advance the foil.

The device includes in particular the data processing system.

The components of the system include, for example, a processor and a memory in which commands to be executed by the processor are stored, as well as data lines or transmission devices which enable the transmission of commands, measurements, data or the like between the listed elements.

A computer program is also proposed, comprising commands which, when the program is executed by a computer, cause it to execute the described method or the steps of the described method.

A computer-readable storage medium is also proposed, comprising commands which, when executed by a computer, cause it to carry out the described method or the steps of the described method.

A battery cell is also proposed, at least comprising a housing and arranged in it a stack of electrode foils, which are produced in particular by the described method and/or with the described winding core.

A motor vehicle is also proposed, at least comprising a traction drive and a battery with at least one of the battery cells described, wherein the traction drive can be supplied with energy by at least one battery cell.

The examples of the method are transferable in particular to the coil, the device, the battery cell, the motor vehicle, the data processing system and the computer-implemented method (i.e., the computer or processor, the computer-readable storage medium), and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a device with a first winding core and a second winding core;

FIG. 2 shows a winding core in a perspective view; and

FIG. 3 shows a section of the device according to FIG. 1.

### DETAILED DESCRIPTION

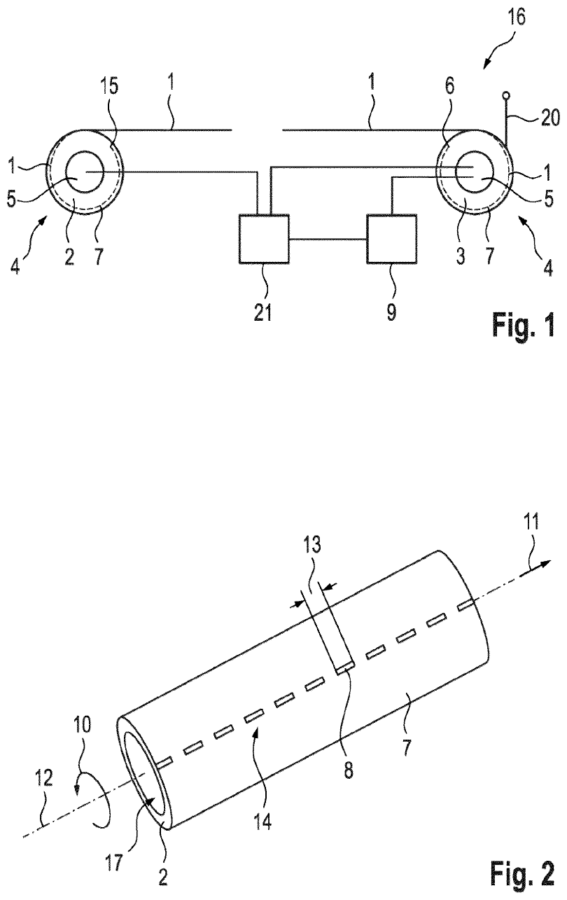

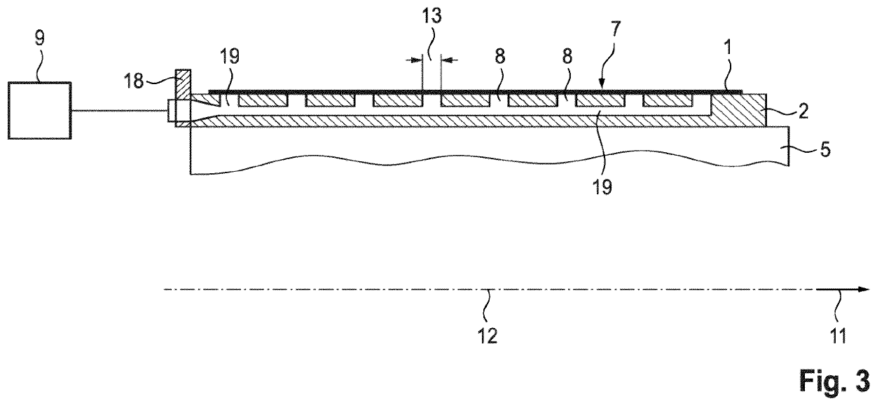

FIG. 1 shows a device 16 with a first winding core 2 and a second winding core 3. FIG. 2 shows a winding core 2, 3 in a perspective view. FIG. 3 shows a section of the device 16 according to FIG. 1. FIGS. 1 to 3 are described together below.

The device 16 comprises two winding cores 2, 3, each arranged on a shaft 5 as well as a vacuum source 9 for each winding core 2, 3. The vacuum source 9 is connected to the winding core 2, 3 via a suitable connection or coupling (see FIG. 3). A control unit 21 is also provided for controlling the device 16.

The second winding core 3 is used to wind the foil 1 and to form a coil 4 together with the second winding core 3. The first winding core 2 is used to unwind the foil 1 from the first winding core 2. The foil 1 comprises a support material of an electrode foil, an electrode foil which has at least one active material, or a separator foil, which are used as components of a battery cell. The winding cores 2, 3 each have a perforated circumferential surface 7 contacting the coiled foil 1, each with a plurality of openings 8.

Each winding core 2, 3 has an axis of rotation 12 extending along an axial direction 11. The circumferential surface 7 has a plurality of openings 8. The openings 8 may be distributed along a circumferential direction 10, in particular over the entire circumferential surface 7 along the circumferential direction 10.

In FIGS. 2 and 3, the openings 8 are arranged distributed along the axial direction 11.

The openings 8 are each designed as slits in FIGS. 2 and 3.

FIG. 2 shows that the openings 8 are arranged exclusively in a sub-area 17 of the circumferential surface 7, which extends along a circumferential direction 10 over an angular range of approx. 10 angular degrees. This means that the foil 1 can be arranged in step c) at the circumferential surface 7, for example, with the foil 1 covering the openings 8. This can improve the suction of the foil 1, since all or at least a large part of the openings 8 are covered by the foil 1. If, for example, the entire circumferential surface 7 is perforated along the circumferential direction 10, it is possible that the negative pressure over the openings 8 not covered by the foil 1 may be reduced, so that sufficient suction may not be guaranteed.

In FIG. 2, the winding core 2, 3 has a plurality of openings 8 at the circumferential surface 7, which are arranged in a row 14 extending along the axial direction 11. The openings 8 of the row 14 are arranged along the axial direction 11 aligned with each other.

The size 13 of the respective opening 8 and the vacuum at the respective opening 8 is adapted to a deformation strength of the foil 1, so that at least a plastic deformation of the foil 1 is avoided when the foil 1 is sucked through the respective opening 8.

The method described is aimed at the winding (on the second winding core 3 according to FIG. 1) and unwinding (from the first winding core 2 according to FIG. 1) of the foil, wherein the foil 1 wound on the winding core 2, 3, together with the winding core 2, 3, is referred to as a coil 4.

The winding core 2, 3 has a perforated circumferential surface 7 with openings 8. The circumferential surface 7 is hollow cylindrical. The winding core 2, 3 is designed to be suitable for arrangement on a shaft 5, i.e., it has connection dimensions or connection geometries suitable for connection with the shaft 5. The shaft 5 is used for the arrangement (first winding core 2) or additionally for the drive, i.e., the rotation of the winding core (second winding core 3). As a result of the arrangement on the shaft 5, the foil 1 can be wound on the second winding core 3 and unwound from the first winding core 2.

The shaft is designed with a closed circumferential surface 7. The winding core 2, 3 has a frontal connection 18 for the vacuum source 9, wherein the circumferential surface 7 is arranged at a distance from the shaft 5, so that the negative pressure of the vacuum source 9 can be provided at the openings 8 via the (cylindrical) gap 19 between the circumferential surface 7 and the shaft 5 (see FIG. 3). In FIG. 3, the gap 19 is formed within the material of the winding core 2, 3.

The vacuum is used to fix the foil 1 to the circumferential surface 7. Fixing can mean that a suction force is provided via which the foil 1 is sucked into the circumferential surface 7.

The foil 1 does not contain any adhesive components through which the foil 1 could adhere to the circumferential surface 7 of the winding core 2, 3.

In step a), the winding core 2, 3 is provided and the winding core 2, 3 is arranged on a shaft 5.

In step b), the foil 1 is provided as a continuous material, with the foil 1 having a first end 6. The first end 6 is arranged at the circumferential surface 7, fixed there via the vacuum and then the foil 1 is wound (see FIG. 1 with the first end 6 on the second winding core 3). The foil 1 extends over at least one to several layers of foil 1, up to a second end 15 of the foil 1, which in FIG. 1 contacts the circumferential surface 7 of the first winding core 2.

In step c), the first end 6 is arranged on the second winding core 3. The arranging can be done, for example, by a feeder 20, through which the foil 1 is led to the second winding core 3. In this case, the foil 1 attaches itself to the circumferential surface 7 via the first end 6 and is sucked onto the circumferential surface 7 via the openings 8. When arranging, the winding core 2, 3 can stand still or rotate. The foil 1 can be applied to the circumferential surface 7 or continuously fed to the winding core 2, 3. In particular, the arranging also includes the winding of the foil 1, at least to the extent that the foil 1 rests on the circumferential surface 7 along the circumferential direction 10 over an angular range of zero to 360, in particular of at least 15 angular degrees and a maximum of 345 angular degrees.

In particular, during step c), at least partially/possibly fully during step c), the negative pressure is present at the openings 8, so that the foil 1 is brought to bear on the circumferential surface and in particular fixed there.

In step (d), in particular, the foil 1 is wound on the second winding core 3 and the coil 4 is formed.

When unwinding the foil 1, the foil 1 is completely unwound from the first winding core 2 in a continuous process, with the first winding core 2 being adhesive-free immediately after unwinding. Thus, there is no separation step in which the second end 15, which is directly arranged on the circumferential surface 7 of the first winding core 2, is separated from the rest of the foil 1. So the entire foil 1, up to the second end 15, is unwound from the first winding core 2, without the foil 1 being separated in between the first end 6 and the second end 15.

According to FIG. 1, the foil 1 is unwound from the first winding core 2 and the foil 1 is wound on the second winding core 3 and the foil 1 is processed in between, e.g., trimmed or coated or dried or calendered (only indicated). The foil 1 has a first end 6 that directly contacts the circumferential surface 7 of the second winding core 3. The other, second end 15 of the foil 1 directly contacts the circumferential surface 7 of the first winding core 2. The foil 1 is unwound from the first winding core 2 with the second end 15, which directly contacts the circumferential surface 7 of the first winding core 2 and wound with the second end 15 on the second winding core 3. Therefore, there is no separation step in which the second end 15, which is arranged directly on the circumferential surface 7 of the first winding coil 2, is separated from the rest of the foil 1. Thus, the entire foil 1, starting from the first end 6, which is already directly contacting the second winding core 3 in FIG. 1, up to the second end 15, is unwound from the first winding core 2 and wound on the second winding core 3. Thus, the foil 1 is not separated between the first end 5 and the second end 15.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for winding a foil onto a winding core for forming a coil and for unwinding the foil from the winding core, the foil comprising a support material of an electrode foil, an electrode foil that has at least one active material, or a separator foil which are used as components of a battery cell, the method comprising:
providing the winding core and arranging the winding core on a shaft;
providing the foil as a continuous material, the foil having a first end;
arranging the first end of the foil on the winding core;
winding the foil on the winding core and forming the coil, the winding core having a perforated circumferential surface with at least one opening on which the foil is arranged; and
connecting the winding core to a vacuum source via which a vacuum is generated at least at one opening so that the vacuum fixes the foil to the circumferential surface at least during step of arranged the first end of the foil on the winding core.

2. The method according to claim 1, wherein the circumferential surface comprises a plurality of openings, wherein the openings are at least arranged in a distributed manner along a circumferential direction or the winding core has an axis of rotation extending along an axial direction and the openings are arranged in a distributed manner along the axial direction.

3. The method according to claim 2, wherein the openings are at least partially different from each other.

4. The method according to claim 1, wherein the size of the at least one opening and the vacuum at the at least one opening is adapted to a deformation strength of the foil so that at least a plastic deformation of the foil is avoided by the foil being sucked through the at least one opening.

5. The method according to claim 1, wherein the fixation of the foil to the circumferential surface is carried out without adhesives during winding.

6. The method according to claim 1, wherein during unwinding, the foil is completely unwound from the winding core in a continuous process, and wherein the winding core is free of adhesives immediately after unwinding.

7. The method according to claim 1, wherein the unwinding of the foil from a first winding core and the winding of the foil on a second winding core is carried out and the foil is processed in between, and wherein the foil is unwound with the first end from the first winding core and with the first end on the second winding core.

8. A coil comprising:
a winding core; and
a foil wound on the winding core, the foil comprising a support material of an electrode foil, an electrode foil, which has at least one active material, or a separator foil which are used as components of a battery cell,
wherein the winding core has a perforated circumferential surface contacting the coiled foil with at least one opening.

9. The coil according to claim 8, wherein the circumferential surface comprises a plurality of openings, wherein the openings are arranged in a distributed manner at least along a circumferential direction or the winding core has an axis of rotation extending along an axial direction and the openings are arranged in a distributed manner along the axial direction.

10. The coil according to claim 9, wherein the openings are at least partially different from each other.
